(19) United States
(12) Patent Application Publication
(10) Pub. No.: US 2014/0223072 A1
(43) Pub. Date: Aug. 7, 2014

(54) Tiered Caching Using Single Level Cell and Multi-Level Cell Flash Technology

(71) Applicant: LSI CORPORATION, San Jose, CA (US)

(72) Inventors: Vinay Bangalore Shivashankaraiah, Bangalore (IN); Mark Ish, Sandy Springs, GA (US)

(73) Assignee: LSI CORPORATION, San Jose, CA (US)

(21) Appl. No.: 13/761,608

(22) Filed: Feb. 7, 2013

(51) Int. Cl. G06F 12/02

(52) U.S. Cl. CPC G06F 12/0246
USPC 711/103; 711/119

(57) ABSTRACT

A data storage system includes two tiers of caching memory. Cached data is organized into cache windows, and the cache windows are organized into a plurality of priority queues. Cache windows are moved between priority queues on the basis of a threshold data access frequency; only when both a cache window is flagged for promotion and a cache window is flagged for demotion will a swap occur.

### BACKGROUND OF THE INVENTION

In data storage systems, caching is the process of saving copying frequently used data to higher speed memory for improved performance. Different memory technologies can be used for caching. Single level cell flash memory elements provide superior performance and endurance as compared to multi-level cell flash memory elements, but are also more expensive. Furthermore, moving data in and out of a cache repeatedly causes thrashing, which degrades memory elements.

Consequently, it would be advantageous if an apparatus existed that is suitable for use as a multi-tiered cache, and suitable for reducing thrashing in a cache.

### SUMMARY OF THE INVENTION

Accordingly, the present invention is directed to a novel method and apparatus for establishing a multi-tiered cache, and reducing thrashing in a cache.

In at least one embodiment of the present invention, a data storage system includes two tiers of caching memory; a higher performance single level cell flash memory element and a lower performance multi-level cell flash memory element. Cached data is organized into cache windows, and the cache windows are organized into a plurality of priority queues. Cache windows are moved between priority queues on the basis of a threshold data access frequency; only when both a cache window is flagged for promotion and a cache window is flagged for demotion will a swap occur.

It is to be understood that both the foregoing general description and the following detailed description are exemplary and explanatory only and are not restrictive of the invention claimed. The accompanying drawings, which are incorporated in and constitute a part of the specification, illustrate an embodiment of the invention and together with the general description, serve to explain the principles.

### BRIEF DESCRIPTION OF THE DRAWINGS

The numerous advantages of the present invention may be better understood by those skilled in the art by reference to the accompanying figures in which:

FIG. 1 shows a block diagram of flash devices organized into cache windows;

FIG. 2 shows a block diagram of a plurality of memory cache windows organized into tiers;

FIG. 3 shows a block diagram of a computer apparatus for implementing a tiered cache memory system;

FIG. 4 shows a flowchart of a method for organizing data into tiered memory cache windows; and

FIG. 5 shows a flowchart of a method for swapping memory cache windows in a tiered memory architecture.

### DETAILED DESCRIPTION OF THE INVENTION

Reference will now be made in detail to the subject matter disclosed, which is illustrated in the accompanying drawings. The scope of the invention is limited only by the claims; numerous alternatives, modifications and equivalents are encompassed. For the purpose of clarity, technical material that is known in the technical fields related to the embodiments has not been described in detail to avoid unnecessarily obscuring the description.

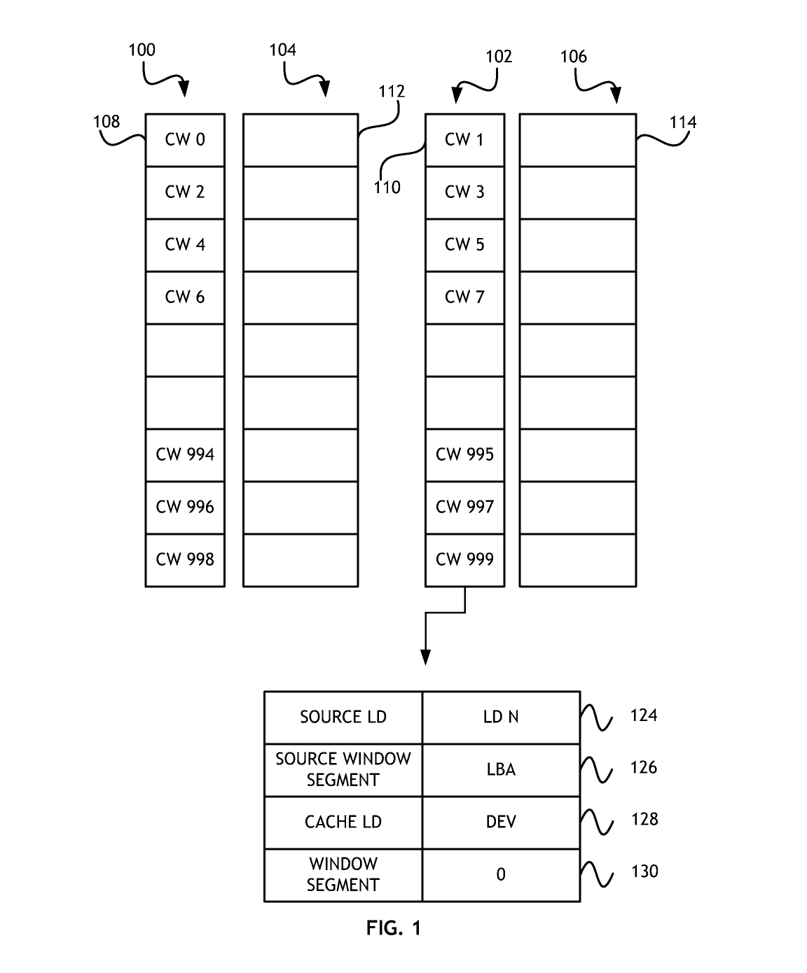

Referring to FIG. 1, a block diagram of flash devices organized into cache windows is shown. In at least one embodiment of the present invention, a memory device includes a first flash memory 104 and a second flash memory 106. In one embodiment, the memory device is a serial attached small computer system interface (SAS) card configured for use as a host bus adapter. Such a memory device connects to one or more data storage elements such that the first flash memory 104 and second flash memory 106 are caches for the one or more data storage elements.

In at least one embodiment of the present invention, the first flash memory 104 and second flash memory 106 has different performance specifications and costs. For example, in at least one embodiment, the first flash memory 104 is a single level cell technology and the second flash memory 106 is a multi-level cell technology. Performance and endurance of multi-level cell technology degrades faster than single level cell technology in write intensive applications; however, single level cell technology is more expensive than multi-level cell technology.

In at least one embodiment of the present invention, the first flash memory 104 and second flash memory 106 are utilized as caches for one or more data storage elements such that data associated with write intensive operations is cached in a memory element suitable for write intensive operations such as the first flash memory 104 while other data is cached in a less expensive memory element such as the second flash memory 106.

In at least one embodiment of the present invention, the first flash memory 104 and second flash memory 106 are divided into memory chunks; for example, each flash memory 104, 106 is divided into one megabyte chunks. Each memory chunk is associated with a cache window 108, 110. In one embodiment, each cache window 108, 110 contains a data structure identifying aspects of a memory chunk in one of the flash memories 104, 106 and a corresponding memory chunk in a data storage element cached in the flash memory 104, 106 memory chunk. In at least one embodiment, each cache window 108, 110 identifies a data source device 124 such as a particular hard drive where the cached data originated, a logical block address 126 identifying where the cached data is stored in the data source device 124, a data cache device 128 identifying which cache device the data is cached in (for example, either the first flash memory 104 or the second flash memory 106) and a cache window segment identifier 130.

In at least one embodiment of the present invention, cache windows are organized into cache window lists 100, 102. In the context of the present application, lists should be understood to include queues and other data structures useful for organizing data elements. In at least one embodiment, cache window lists 100, 102 are maintained in a memory element on the memory device such as a dynamic random access memory element. Cache windows 108, 110 are accessed through a hash table or a least recently used list maintained by the memory device.

Initially, all cache windows 108, 110 are added to a list of available cache windows. A separate pool of virtual cache windows is allocated by a processor on the memory device to maintain statistical information for regions of a data storage device that could potentially be recommended for caching; each virtual cache window is associable with a region of a memory chunk of a data storage device. As data is accessed from one or more data storage devices, the processor may associate that region of the data storage device with a virtual cache window or update access statistics in a virtual cache window already associated with such region. In one embodiment, a threshold value is set for caching a region of a data storage device; for example, a region is cached when it is accessed three times.

As cache windows 108, 110 are associated with regions of data storage devices, such cache windows 108, 110 are removed from the list of available cache windows. In at least one embodiment, cache windows 108, 110 associated with regions of data storage devices are added to a least recently used list; the order of cache windows 108, 110 in such least recently used list are reordered based on the frequency of data access. In another embodiment, cache windows 108, 110 are placed in one of a plurality of least recently used lists, each of the least recently used lists associated with a priority. 108, 110 Once all of the cache windows 108, 110 in the list of available cache windows are associated with regions of data storage devices, the least used cache window 108, 110 as measured by access frequency of the data associated with the cache window 108, 110 in the least recently used list. In at least one embodiment of the present invention, separate least recently used lists are maintained for cache windows 108 associated with the first flash memory 104 and for cache windows 110 associated with the second flash memory 106. In another embodiment of the present invention, a memory device includes a plurality of least recently used lists, each least recently used list associated with a first flash memory 104 and a second flash memory 106. In such an embodiment, the least recently used lists are organized into priority queues.

In at least one embodiment, a tiered cache as described herein utilizes higher performance memory elements, such as single level cell flash memory, to cache more frequently accessed data and more write intensive data while using more cost effective memory elements, such as multi-level cell flash memory, for the remaining cached data. For example, such a system could utilize 128GB of single level cell flash memory and 512GB of multi-level cell flash memory for the same cost as a system utilizing only 512GB of single level cell flash memory.

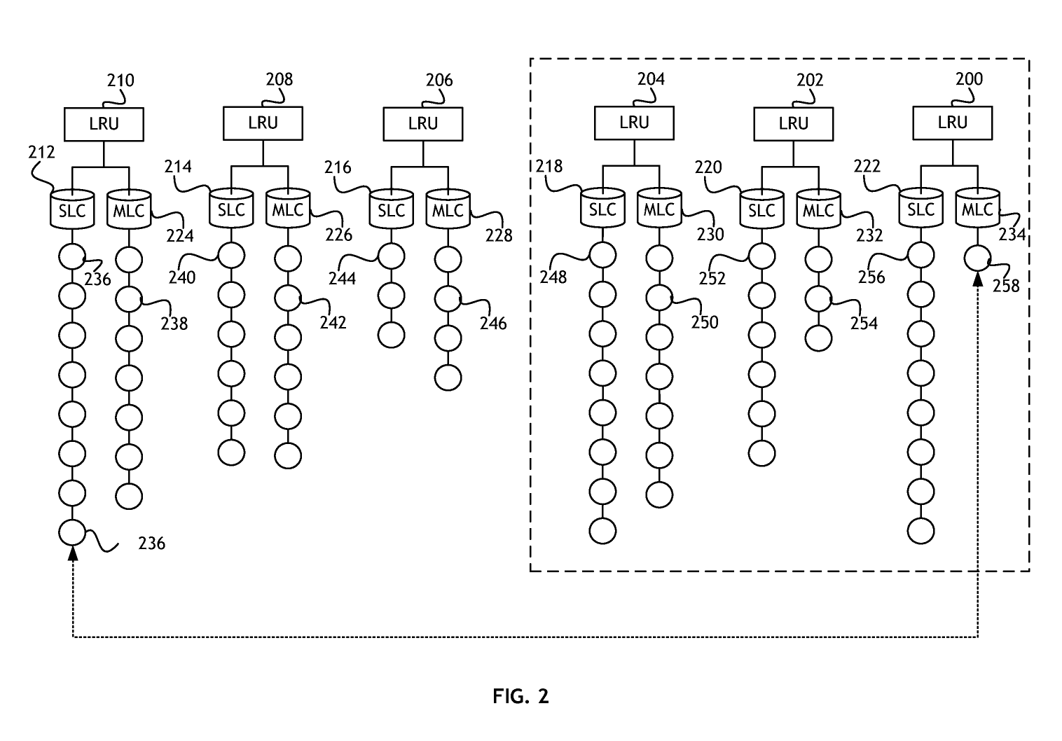

Referring to FIG. 2, a block diagram of a plurality of memory cache windows organized into tiers is shown. In at least one embodiment of the present invention, memory is organized into a plurality of cells, each cell comprising a least recently used priority queue 200, 202, 204, 206, 208, 210; each least recently used priority queue 200, 202, 204, 206, 208, 210 associated with a single level cell cache memory 212, 214, 216, 218, 220, 222 and a multi-level cell cache memory 224, 226, 228, 230, 232, 234. In one embodiment, the single level cell cache memory 212, 214, 216, 218, 220, 222 comprises a “hot” tier and the a multi-level cell cache memory 224, 226, 228, 230, 232, 234 comprises a relatively “cold” tier for data accessed frequently enough to warrant caching but not as frequently as data in the “hot” tier.

In at least one embodiment, single level cell cache memory 212, 214, 216, 218, 220, 222 and multi-level cell cache memory 224, 226, 228, 230, 232, 234 is organized into discreet cache windows 236, 238, 240, 242, 244, 246, 248, 250, 252, 254, 256, 258. Each cache windows 236, 238, 240, 242, 244, 246, 248, 250, 252, 254, 256, 258 represents a memory block associated with a usage value indicating the relative heat of the data in the memory block, and a memory address of the memory block.

In one embodiment of the present invention, cache windows 236, 238, 240, 242, 244, 246, 248, 250, 252, 254, 256, 258 are promoted and demoted by moving from a first least recently used priority queue 200, 202, 204, 206, 208, 210 having a first priority to a second least recently used priority queue 200, 202, 204, 206, 208, 210 having a second priority. In one embodiment, cache windows 236, 238, 240, 242, 244, 246, 248, 250, 252, 254, 256, 258 are only promoted or demoted between a “hot” tier and “cold” tier when promotion or demotion takes place between the highest priority least recently used priority queue 200, 202, 204, 206, 208, 210 and the lowest priority least recently used priority queue 200, 202, 204, 206, 208, 210. For example, a cache window 258 in the “cold” tier 234 of the highest priority least recently used priority queue 200 is swapped with a cache window 236 in the “hot” tier 212 of the lowest priority least recently used priority queue 210. In at least one embodiment, swapping includes locking both the cache window 258 in the “cold” tier 234 and the cache window 236 in the “hot” tier 212 to prevent host access. Data in the cache window 236 in the “hot” tier 212 is copied to a temporary memory buffer, data in the cache window 258 in the “cold” tier 234 is copied to the “hot” tier 212, data in the temporary memory buffer is copied to the “cold” tier 234 and appropriate cache window data structures are updated to reflect the change.

In one embodiment of the present invention, a processor defines a threshold of access frequency to promote or demote cache windows. Swaps only occur when a cache window in one least recently used priority queue is flagged for promotion and a different cache window in a different least recently used priority queue is flagged for demotion such that the positions of the two cache windows would be swapped. Thresholds limit thrashing.

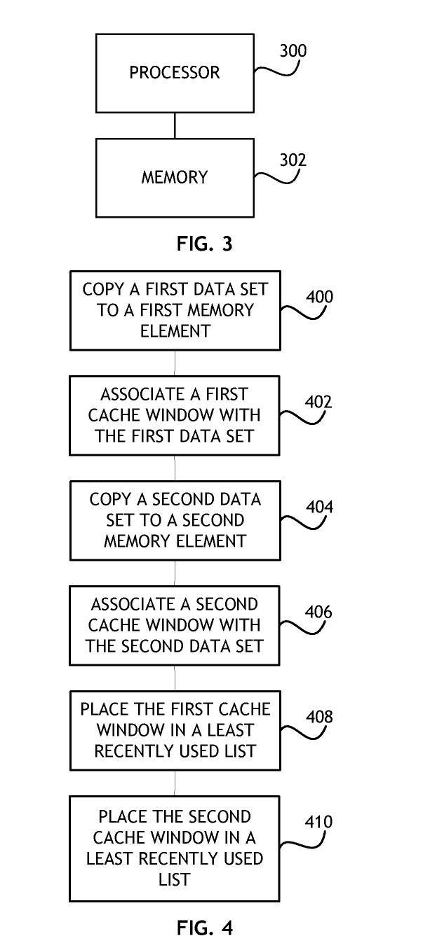

Referring to FIG. 3, a block diagram of a computer apparatus for implementing a tiered cache memory system is shown. In one embodiment of the present invention, a memory device includes a processor 300 and a memory element 302 connected to the processor 300. The memory element 302 stores data structures for tracking cache windows in one or more least recently used lists. The processor 300 is configured add data to a cache and organize cache windows into “hot” and “cold” tiers defined by memory technology used to instantiate the “hot” and “cold” tiers. In at least one embodiment of the present invention, the processor 300 tracks the frequency of data access and reorganizes data in a cache moving cache windows from one least recently used list to another least recently list having a different priority.

Referring to FIG. 4, a flowchart of a method for organizing data into tiered memory cache windows is shown. In at least one embodiment of the present invention, a first data set in a data storage device receives enough hits to warrant caching. The first data set is copied 400 to a first memory element. In one embodiment, the first memory element is a flash memory having certain performance criteria. A first cache window is then associated 402 with the first data set.

A second data set in a data storage device also receives enough hits to warrant caching. The second data set is copied 404 to a second memory element. In one embodiment, the second memory element is a flash memory having performance characteristics different from those of the first memory element. In one embodiment, the first memory element is a single level cell technology flash memory and the second memory element is a multi-level cell technology flash memory. A second cache window is then associated 406 with the second data set.

In at least one embodiment, the first cache window is placed 408 in a least recently used list; such list may be a priority queue. The second cache window is also placed 410 in a least recently used list. In one embodiment, the first cache window and second cache window are placed 408, 410 in the same least recently used list. In at least one embodiment, cache windows associated with the first memory element and cache windows associated with the second memory element are organized into a plurality of least recently used lists, each least recently used list having a unique priority value as compared to the other least recently used lists.

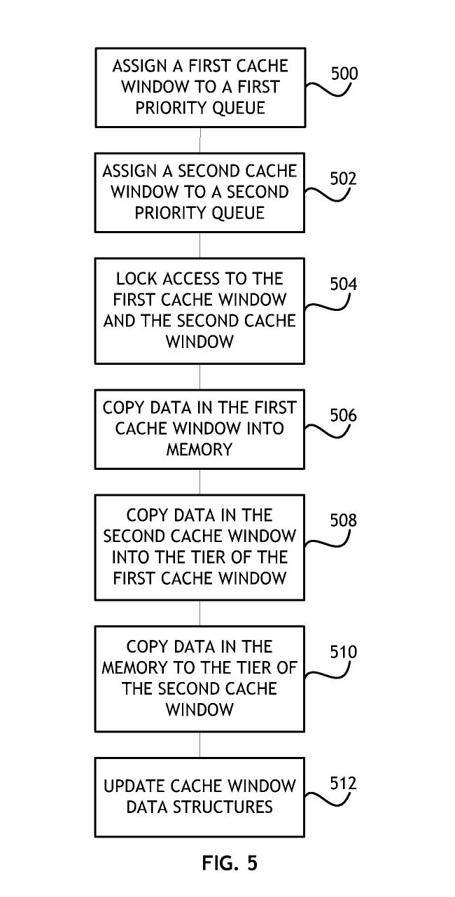

Referring to FIG. 5, a flowchart of a method for swapping memory cache windows in a tiered memory architecture is shown. In at least one embodiment of the present invention, where access frequency to cached data changes over time, a first cache window is assigned 500 to a first priority queue and a second cache window is assigned 502 to a second priority queue. In the context of the present invention, a priority queue is embodied in a data structure such as a least recently used list. When a processor determines that the first cache window and the second cache window should be swapped, the processor locks 504 access to the first cache window and the second cache window. In one embodiment, the determination that the first cache window and the second cache window should be swapped is based on the first cache window crossing a threshold for demotion and the second cache window crossing a threshold for promotion.

Data from the first cache window is copied 506 to a temporary memory buffer, data in the second cache window is copied 508 to the memory element identified by the first cache window and the data copied 506 to the temporary memory buffer is copied 510 to the memory element identified by the second cache window. The first cache window data structure and second cache window data structure are then updated 512 to reflect the new tier and position of each data set.

It is believed that the present invention and many of its attendant advantages will be understood by the foregoing description of embodiments of the present invention, and it will be apparent that various changes may be made in the form, construction, and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for caching data comprising:
copying a first data set to a first cache memory element;
associating the first data set with a first cache window;
copying a second data set to a second cache memory element;
associating the second data set with a second cache window;
placing the first cache window in a first least recently used list; and
placing the second cache window in a second least recently used list.

2. The method of claim 1, wherein the first cache memory element comprises a single level cell flash memory.

3. The method of claim 2, wherein the second cache memory element comprises a multi-level cell flash memory.

4. The method of claim 1, wherein the second cache memory element comprises a multi-level cell flash memory.

5. The method of claim 1, further comprising:
allocating a pool of virtual cache windows;
associating one or more virtual cache windows with one or more regions of a data storage device; and
updating the one or more virtual cache windows based on access frequency of the associated region of the data storage device.

6. The method of claim 5, further comprising copying the first data set based on a threshold access frequency, wherein the first data set is associated with one of the virtual cache windows in the pool of virtual cache windows.

7. A method for organizing cached data comprising:
assigning a first cache window to a first priority queue;
assigning a second cache window to a second priority queue;
locking access to the first cache window and the second cache window;
copying data associated with the first cache window into a memory buffer;
copying data associated with the second cache window to a cache memory element associated with the first cache window;
copying data in the memory buffer to a cache memory element associated with the second cache window; and
updating data structures associated with the first cache window and the second cache window.

8. The method of claim 7, wherein the cache memory element associated with the first cache window comprises a single level cell flash memory.

9. The method of claim 8, wherein the cache memory element associated with the second cache window comprises a multi-level cell flash memory.

10. The method of claim 7, wherein the cache memory element associated with the second cache window comprises a multi-level cell flash memory.

11. The method of claim 7, further comprising establishing a promotion threshold and a demotion threshold for cache windows.

12. The method of claim 11, wherein first cache window has crossed the demotion threshold and the second cache window has crossed the promotion threshold.

13. A data storage system comprising:
a processor;
a random access memory connected to the processor;
a data storage element connected to the processor;
a first cache memory element connected to the processor;
a second cache memory element connected to the processor; and
computer executable program code,
wherein the computer executable program code is configured to:
copy a first data set to the first cache memory element;
associate the first data set with a first cache window;
copy a second data set to the second cache memory element;
associate the second data set with a second cache window;
place the first cache window in a first least recently used list; and
place the second cache window in a second least recently used list.

14. The system of claim 13, wherein the first cache memory element comprises a single level cell flash memory.

15. The system of claim 14, wherein the second cache memory element comprises a multi-level cell flash memory.

16. The system of claim 13, wherein the second cache memory element comprises a multi-level cell flash memory.

17. The system of claim 13, wherein the computer executable program code is further configured to:
allocate a pool of virtual cache windows;
associate one or more virtual cache windows with one or more regions of the data storage element; and
update the one or more virtual cache windows based on access frequency of the associated region of the data storage element.

18. The system of claim 13, wherein the computer executable program code is further configured to:
establish a promotion threshold and a demotion threshold for cache windows based on one or more data access frequencies; and
prevent promotion and demotion between the first least recently used list and the second least recently used list until the first cache window passes the threshold for demotion and the second cache window passes the threshold for promotion.

19. The system of claim 18, wherein the promotion threshold and demotion threshold are configured to prevent thrashing of the first cache memory element and second cache memory element.

20. The system of claim 18, wherein the computer executable program code is further configured to:
lock access to the first cache window and the second cache window;
copy data associated with the first cache window into the random access memory;
copy data associated with the second cache window to the first cache memory element;
copy data in the memory buffer to the second cache memory element; and
update data structures associated with the first cache window and the second cache window.
